(19) United States
(12) Patent Application Publication
(10) Pub. No.: US 2006/0139527 A1
(43) Pub. Date: Jun. 29, 2006

(54) Liquid crystal display device with transmission and reflective display modes and method of displaying balanced chromaticity image for the same

(76) Inventors: Wei-Chih Chang, Miao Li County (TW); Li-Sen Chuang, Miao Li County (TW); Dai-Liang Ting, Miao Li County (TW)

Correspondence Address: LIU & LIU, 444 S. FLOWER STREET, SUITE 1750, LOS ANGELES, CA, 90071, US

(21) Appl. No.: 11/317,447

(22) Filed: Dec. 23, 2005

Related U.S. Application Data
(63) Continuation-in-part of application No. 11/023,219, filed on Dec. 27, 2004.
(60) Provisional application No. 60/654,373, filed on Feb. 18, 2005.

(51) Int. Cl. G02F 1/1335

(52) U.S. Cl. 349/114

(57) ABSTRACT

A method of displaying balanced chromatic images for a liquid crystal display (LCD) device with a transmissive display mode and a reflective display mode. The LCD device generates an output image in the transmissive mode with a first white output signal Wo, whereby the brightness increases of red, green and blue, the saturations of which are not decreased from an input image. The LCD device generates an output image in the reflective mode with a second white output signal Wo′, whereby the brightness increases of red, green and blue, the hues of which are not decreased from an input image, but the saturations of which decrease. The first white output signal Wo in the transmissive mode is different from the second white output signal Wo′ in the reflective mode.

### CROSS REFERENCE TO RELATED APPILCATIONS

This application is a Continuation-In-Part of pending U.S. patent application Ser. No. 11/023,219, filed on Dec. 27, 2004 and entitled “transflective liquid crystal display device with balanced chromaticity”, the teachings of which are incorporated herein by reference.

### BACKGROUND OF THE INVENTION

1. Field of the Invention

The present invention relates to methods of image processing of liquid crystal display (LCD) devices, and more particularly to methods of displaying balanced chromatic images for LCD devices.

2. Description of the Related Art

Liquid crystal display (LCD) devices are widely used as displays in electronic devices such as portable computers, PDAs and cell phones. Liquid crystal display devices are classified into two types. One is transmissive type, and the other is reflective type. The former utilizes a backlight as the light source and the latter utilizes ambient light. It is difficult to reduce power consumption in transmissive LCDs due to the power requirements of the backlight. Reflective LCDs have the advantage of lower power consumption under bright ambient light, but are hindered by environments with less ambient light.

In order to overcome the drawbacks of these two types of LCDs, a transflective LCD is disclosed. Transflective LCDs are capable of displaying images in both transmissive and reflective modes. Under bright ambient light, the backlight can be turned off to reduce power consumption to lower than that of a transmissive LCD. Additionally, when less ambient light is available, the backlight can be turned on, thus offering improved image quality over that of reflective LCDs.

FIG. 1 is an exploded perspective view illustrating a typical transflective LCD device. The transflective LCD device includes an upper substrate 10 and a lower substrate 20 with a liquid crystal layer 50 interposed therebetween. The upper substrate 10 is a color filter substrate and the lower substrate 20 is an array substrate. In the upper substrate 10, on a surface opposing the lower substrate 20, a black matrix 12 and a color filter layer 14 including a plurality of red (R), green (G) and blue (B) color filters is formed. That is, the black matrix 12 surrounds each color filter, in the shape of an array matrix. Further on the upper substrate 10, a common electrode 16 is formed to cover the color filter layer 14 and the black matrix 12.

In the lower substrate 20, on a surface opposing the upper substrate 10, a TFT “T” serving as a switching device is formed in the shape of an array matrix corresponding to the color filter layer 14. In addition, a plurality of crossing gate and data lines 26 and 28 are positioned such that each TFT is located near each cross point of the gate and data lines 26 and 28. Further on the lower substrate 20, a plurality of pixel regions (P) is defined by the gate and data lines 26 and 28. Each pixel region P has a pixel electrode 22 comprising a transparent portion 22a and an opaque portion 22b. The transparent portion 22a comprises a transparent conductive material, such as ITO (indium tin oxide) or IZO (indium zinc oxide), and the opaque portion 22b comprises a metal having high reflectivity, such as Al (aluminum).

FIG. 2 is a sectional view of a conventional transflective LCD device, which helps to illustrate the operation of such a device. As shown in FIG. 2, the conventional transflective LCD device includes a lower substrate 200, an upper substrate 260 and a liquid crystal layer 230 interposed therebetween. The upper substrate 260 has a common electrode 240 and a color filter 250 formed thereon. The color filter 250 includes red (R), green (G) and blue (B) regions. The lower substrate 200 has an insulating layer 210 and a pixel electrode 220 formed thereon, wherein the pixel electrode 220 has an opaque portion 222 and a transparent portion 224. The opaque portion 222 of the pixel electrode 220 can be an aluminum layer, and the transparent portion 224 of the pixel electrode 220 can be an ITO (indium tin oxide) layer. The opaque portion 222 reflects ambient light 270, while the transparent portion 224 transmits light 280 from a backlight device 290 disposed at the exterior side of the lower substrate 200. The liquid crystal layer 230 is interposed between the lower and upper substrates 200 and 260. Therefore, the transflective LCD device is capable of display in both reflective and transmissive modes.

Referring to FIG. 2, the backlight 280 penetrates the transmissive portion 224 and passes through the color filter 250 once, and the ambient light 270 is reflected by the reflective portion 222 and passes through the color filter 250 twice. This leads to different chromaticity in the reflective and transmissive regions, decreasing display quality.

U.S. Pat. No. 5,233,385 discloses a method for increasing the brightness of a scene in a color projection. This method uses a white light to raise the brightness in both temporal and spatial filtering systems.

U.S. Pat. No. 5,929,843 discloses a method and apparatus for processing image data comprising the steps of extracting white component data from input R, G, B data, suppressing the white component data in accordance with a non-linear characteristic, generating R, G, B, W display data and driving a liquid crystal display panel having R, G, B, W filters in accordance with R, G, B, W data in order to display a full color image.

U.S. Publication No. 2004/0046725 discloses a four color liquid crystal display including R, G, B and W pixels, for improving optical efficiency.

Moreover, U.S. Publication No. 2003/0128872, the entirety of which is hereby incorporated by reference, discloses a method for generating a white signal component and for controlling the brightness of an image of a transmissive LCD.

None of the above cited references are directed to LCD devices with balanced chromatic image in the transmissive and the reflective displaying modes.

### BRIEF SUMMARY OF INVENTION

The invention is directed to a novel method for displaying balanced chromatic images for an LCD and an LCD structure configured to reduce the difference in chromaticity between the transmissive mode and the reflective mode by providing a substantively white light. In one aspect of the present invention, a novel structure is disclosed wherein the pixel area comprises a white sub-pixel area providing a white light in the reflective mode, compared to the transmissive mode. In another aspect of the present invention, a method for normalizing chromaticity between transmissive and reflective modes of a transflective LCD device is disclosed. The structure and method of the present invention comprises the provision of a white sub-pixel area that supports a white light to increase brightness in the reflective mode, compared to the transmissive mode.

The invention provides a method of displaying balanced chromatic images for a liquid crystal display (LCD) device with a transmissive mode and a reflective mode. The method comprises displaying images on the LCD device in the transmissive mode with a first white output signal, and displaying images on the LCD device in the reflective mode with a second white output signal, wherein the first white output signal is different from the second white output signal.

The invention also provides a method of displaying balanced chromatic image for a liquid crystal display (LCD) device with a transmissive mode and a reflective mode. The method comprises displaying the LCD device in the transmissive mode without a white input signal, and displaying the LCD device in the reflective mode with a white output signal, wherein the white output signal equals a×Ri+b×Gi+c×Bi, where 0<a<1, 0<b<1, or 0<c<1 respectively.

The invention further provides an LCD device having a plurality of main pixel areas, wherein each main pixel area comprises three primary sub-pixels and a white sub-pixel. Each sub-pixel comprises a transmissive portion and a reflective portion and corresponds to a color filter. The color filter comprises three primary color regions and a white region, wherein the primary sub-pixels correspond to the primary color regions and the white sub-pixel corresponds to the white region. The white region may have no color layer or have a transparent resist layer. When the transflective LCD device is operated in a transmissive mode, the white sub-pixel is driven to not emit light. Conversely, when the transflective LCD device is operated in a reflective mode, the white sub-pixel area is driven to emit light. That is, the white sub-pixel only provides the white light in the reflective mode, thereby normalizing chromaticity between transmissive and reflective modes.

The invention further provides an LCD device comprising a plurality of main pixel areas, wherein each main pixel area comprises three primary sub-pixels and a white sub-pixel and a color filter corresponding to the sub-pixels. Each primary sub-pixel comprises a transmissive portion and a reflective portion and the white sub-pixel is a reflective pixel. The color filter comprises three primary color regions and a white region, wherein the primary sub-pixels correspond to the primary color regions and the white sub-pixel corresponds to the white region. The white region may have no color layer or have a transparent resist layer. When the transflective LCD device is operated in a transmissive mode, there is no light transmitted through the white sub-pixel. Conversely, when the transflective LCD device is operated in a reflective mode, the white sub-pixel reflects ambient light to display white light, thereby normalizing chromaticity between transmissive and reflective modes.

The invention further provides a liquid crystal display (LCD) device with three primary color sub-pixels and a white sub-pixel. A first substrate and a second substrate are disposed opposite to each other with a liquid crystal layer interposed therebetween. A transparent electrode is disposed on the first substrate at each of the three primary color sub-pixels. An electrode with a reflective portion is disposed on the first substrate at the white sub-pixel.

### BRIEF DESCRIPTION OF DRAWINGS

The invention can be more fully understood by reading the subsequent detailed description in conjunction with the examples and references made to the accompanying drawings, wherein:

FIG. 1 is an exploded perspective view illustrating a typical transflective LCD device;

FIG. 2 is a sectional view illustrating operation of a conventional transflective LCD device;

FIG. 3 illustrates a part of a transflective LCD device according to the present invention, showing a main pixel area consisting of three primary color sub-pixel areas and a white sub-pixel area;

FIG. 4 is a sectional view of a transflective LCD device according to a first embodiment of the invention, illustrating the operation thereof in a transmissive mode;

FIG. 5 is a sectional view of a transflective LCD device according to a second embodiment of the present invention, illustrating the operation thereof in a transmissive mode;

FIG. 6 is a sectional view of a transflective LCD device according to a third embodiment of the invention, illustrating the operation thereof in a transmissive mode;

FIG. 7 is a sectional view of a transflective LCD device according to a fourth embodiment of the invention, illustrating the operation thereof in a transmissive mode;

FIG. 8 is a sectional view of a transflective LCD device according to a fifth embodiment of the invention, illustrating the operation thereof in a transmissive mode;

FIG. 9A is a block diagram illustrating a method of displaying balanced chromatic image for a liquid crystal display (LCD) device in a transmissive display mode;

FIG. 9B is a block diagram illustrating a method of displaying balanced chromatic image for a liquid crystal display (LCD) device in a reflective display mode;

FIG. 10 is a CIE chromaticity diagram showing color gamut in reflective mode and in transmissive mode according to the present invention;

FIG. 11 is a schematic diagram of an LCD module comprising an embodiment of an LCD device; and

FIG. 12 is a schematic diagram of an electronic device, incorporating an LCD module comprising an embodiment of the LCD device.

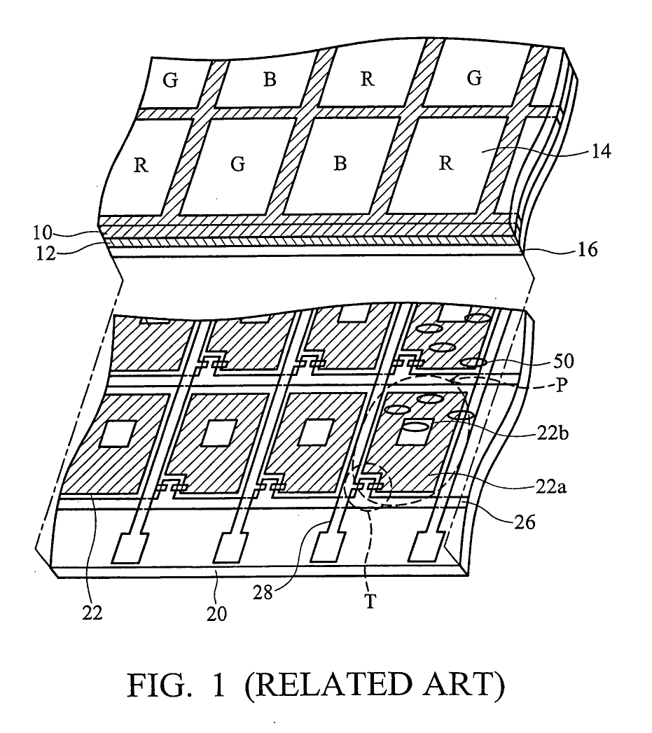

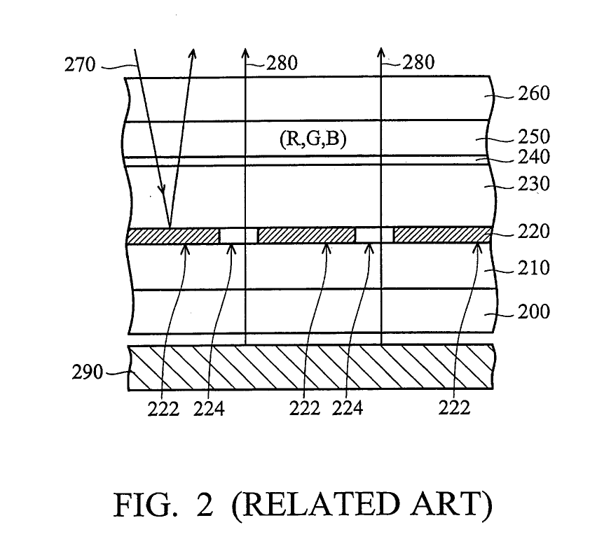

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

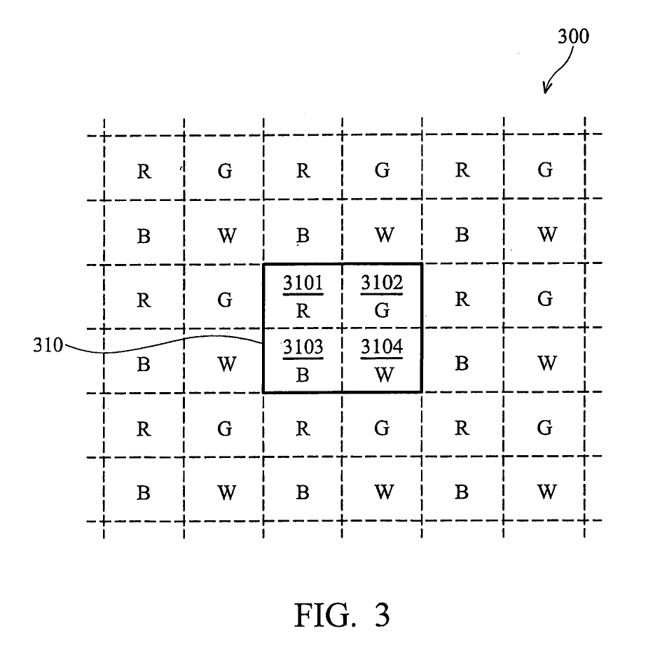

FIG. 3 illustrates a portion of a transflective LCD device 300 according to one embodiment of the present invention. The transflective LCD device 300 comprises a plurality of main pixel areas 310, wherein each main pixel area 310 consists of at least one color sub-pixel area (three primary color sub-pixel areas 3101, 3102 and 3103 are represented hereinafter) and a white sub-pixel area 3104. In FIG. 3, numeral “3101” represents a red (R) sub-pixel area, numeral “3102” represents a green (G) sub-pixel area and numeral “3103” represents a blue (B) sub-pixel area. The arrangement of the sub-pixel areas 3101, 3102, 3103 and 3104 is a chessboard type shown in FIG. 3, but is not intended to limit the present invention. That is, the arrangement of the sub-pixel areas 3101, 3102, 3103 and 3104 can be a stripe type, a mosaic type, a delta type or others.

### First Embodiment

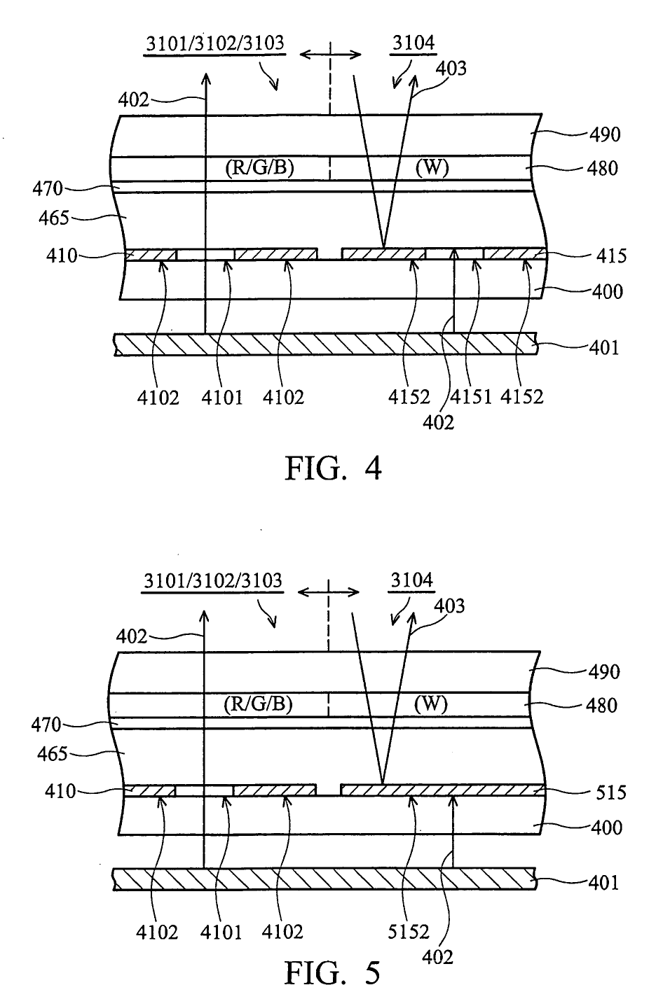

FIG. 4 is a sectional view schematically showing one main pixel area 310 of the transflective LCD device 300 according to the first embodiment of the present invention. The main pixel area 310 comprises red, green and blue sub-pixel areas 3101, 3102 and 3103 and a white sub-pixel area 3104. For simplicity, the three primary color sub-pixel areas 3101, 3102, and 3103 and a white sub-pixel area 3104 are respectively shown in FIG. 4.

A first substrate 400, serving as a lower substrate, can be a glass substrate including an array of pixel driving elements (not shown), such as an array of thin film transistors (TFTs). A backlight device 401 is disposed at the outer side (i.e. the backside) of the first substrate 400. Three sub-pixel electrodes 410 and a sub-pixel electrode 415 are formed on the first substrate 400, wherein each sub-pixel electrode 410 is located in each primary color sub-pixel area 3101/3102/3103 and the sub-pixel electrode 415 is located in the white sub-pixel area 3104. Note that a representative sub-pixel electrode 410 is shown in FIG. 4. Each sub-pixel electrode 410 comprises a first transmissive portion 4101 and a first reflective portion 4102. The sub-pixel electrode 415 comprises a second transmissive portion 4151 and a second reflective portion 4152. The first and second transmissive portions 4101 and 4151 can be a transparent conductive material such as ITO (indium tin oxide) or IZO (indium zinc oxide). The first and second reflective portions 4102 and 4152 can be opaque and reflective materials such as aluminum, aluminum alloy or silver.

A second substrate 490, such as glass, opposite the first substrate 400 is provided. The second substrate 490 serves as an upper substrate. A color filter 480 is formed on the inner side of the second substrate 490. The color filter 480 comprises three primary color regions R, G and B and a white region W. The white region W may have no color layer or have a transparent resist layer. Note that a representative primary color region R/G/B is shown in FIG. 4. Each sub-pixel electrode 410 corresponds to each primary color region RIG/B. The sub-pixel electrode 415 corresponds to the white region W.

A common electrode 470 is then formed on an inner side of the second substrate 490. The common electrode 470 may be an ITO or IZO layer. In FIG. 4, liquid crystal molecules fill a space between the first substrate 400 and the second substrate 490 to form a liquid crystal layer 465. The liquid crystal orientation of the liquid crystal layer 465 is controlled by electric field generating electrodes such as sub-pixel electrodes 410 and 415 and the common electrode 470.

When operating in transmissive mode, a backlight 402 from the backlight device 401 passes through the primary color regions R, G and B once. According to this embodiment, the liquid crystal orientation above the sub-pixel electrode 415 is controlled to transmit backlight at different levels of brightness. In one aspect of this embodiment, when the white sub-pixel area 3104 is driven to not transmit light (i.e. the white sub-pixel area 3104 is dark), the color gamut is preserved in the transmissive mode. In another aspect of this embodiment, when the white sub-pixel area 3104 is allowed to transmit light, the color gamut will change with the different brightness levels.

When operating in reflective mode, a reflective light 403 from an exterior light source (not shown) passes through the primary color regions R, G and B twice, causing display color in the reflective mode to be darker than that in the transmissive mode. At this time, according to the present invention, the liquid crystal orientation above the sub-pixel electrode 415 is controlled to cause the reflective light 403 to penetrate the liquid crystal layer 465 above the second reflective portion 4152 (i.e. the sub-pixel electrode 415). That is, when the white sub-pixel area 3104 is driven to transmit white light to raise display brightness and dilute the color purity in the reflective mode, the color gamut is thereby varied with different brightness levels.

Thus, the overall chromaticity and color gamut for the two modes may be controlled to a desired value, which may be substantially the same or different chromaticity.

### Second Embodiment

FIG. 5 is a sectional view schematically showing one main pixel area of the transflective LCD device according to the second embodiment which is modified from the first embodiment. Elements in FIG. 5 repeated from FIG. 4 use the same numerals. The second embodiment differs from the first embodiment in the sub-pixel electrode 515. The sub-pixel electrode 515 merely comprises a reflective portion 5152. The reflective portion 5152 can be opaque and reflective materials such as aluminum, aluminum alloy or silver. That is, the sub-pixel electrode 515 is a reflective layer.

An operational example of this embodiment is illustrated hereinafter.

When operating in transmissive mode, a backlight 402 emitted from the backlight device 401 passes through the primary color regions R, G and B once. Note that the sub-pixel electrode 515 blocks backlight 402 from the backlight device 401 because the sub-pixel electrode 515 is opaque. That is, the white sub-pixel area 3104 does not transmit light (i.e. the white sub-pixel area 3104 is dark) in the transmissive mode.

When operating in reflective mode, a reflective light 403 from an exterior light source (not shown) passes through the primary color regions R, G and B twice, causing display color in the reflective mode to be darker than that in the transmissive mode. At this time, according to the invention, the white sub-pixel area 3104 displays a white light to raise brightness by reflection of the sub-pixel electrode 515; furthermore, the white sub pixel area can be driven to display different brightness levels to change the color gamut in the reflective mode.

### Third Embodiment

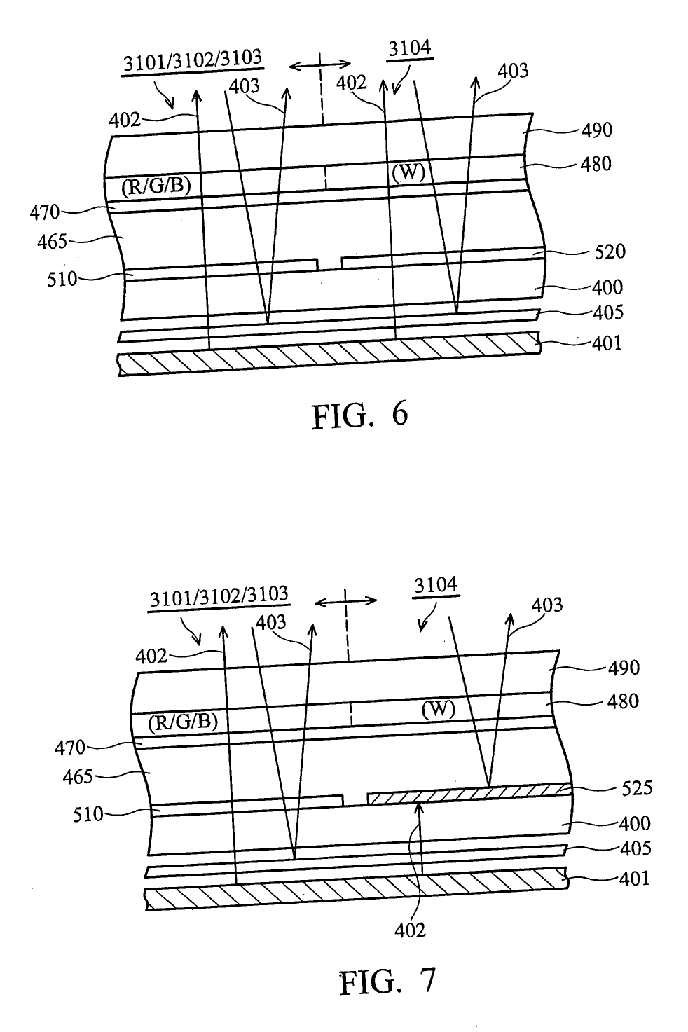

FIG. 6 is a sectional view schematically showing one main pixel area of the transmissive LCD device according to the third embodiment of the present invention. The main pixel area comprises red, green and blue sub-pixel areas 3101, 3102 and 3103 and a white sub-pixel area 3104. For simplicity, the three primary color sub-pixel areas 3101, 3102, and 3103 and a white sub-pixel area 3104 are respectively shown in FIG. 6.

A first substrate 400, serving as a lower substrate, can be a glass substrate including an array of pixel driving elements (not shown), such as an array of thin film transistors (TFTs). A backlight device 401 is disposed at the outer side (i.e. the backside) of the first substrate 400. Three sub-pixel electrodes 510 and a sub-pixel electrode 520 are formed on the first substrate 400, wherein each sub-pixel electrode 510 is located in each primary color sub-pixel area 3101/3102/3103 and the sub-pixel electrode 520 is located in the white sub-pixel area 3104. Note that a representative sub-pixel electrode 510 is shown in FIG. 6. Each sub-pixel electrode 510 and the sub-pixel electrode 520 can be transparent conductive material such as ITO (indium tin oxide) or IZO (indium zinc oxide).

A second substrate 490, such as glass, opposite the first substrate 400 is provided. The second substrate 490 serves as an upper substrate. A color filter 480 is formed on the inner side of the second substrate 490. The color filter 480 comprises three primary color regions R, G and B and a white region W. The white region W may have no color layer or have a transparent resist layer. Note that a representative primary color region R/G/B is shown in FIG. 6. Each sub-pixel electrode 510 corresponds to each primary color region R/G/B. The sub-pixel electrode 520 corresponds to the white region W.

A common electrode 470 is then formed on an inner side of the second substrate 490. The common electrode 470 may be an ITO or IZO layer. In FIG. 6, liquid crystal molecules fill a space between the first substrate 400 and the second substrate 490 to form a liquid crystal layer 465. The liquid crystal orientation of the liquid crystal layer 465 is controlled by electric field generating electrodes such as sub-pixel electrodes 510 and 520 and the common electrode 470. A semi-transmissive layer 405 is disposed between the first substrate 400 and a backlight device 401 (as shown in FIG. 6) or disposed between the sub-pixel electrodes 510 and 520 and the first substrate 400, but the arrangement is not limited to this. The semi-transmissive layer 405 is capable of transmitting backlight and reflecting ambient light, thus, the transmissive LCD can be operated in both transmissive and reflective modes.

When operating in transmissive mode, a backlight 402 from the backlight device 401 passes through the primary color regions R, G and B once. According to this embodiment, the liquid crystal orientation above the sub-pixel electrode 520 is controlled to transmit backlight at different brightness light levels. In one aspect of this embodiment, when the white sub-pixel area 3104 is driven to not transmit light (i.e. the white sub-pixel area 3104 is dark), thus, the color gamut is preserved in the transmissive mode. In another aspect of this embodiment, when the white sub-pixel area 3104 is allowed to transmit light, thus the color gamut will change with the different brightness levels.

When operating in reflective mode, a reflective light 403 from an exterior light source (not shown) passes through the primary color regions R, G and B twice and is reflected by the semi-transmissive layer 405, causing display color in the reflective mode to be darker than that in the transmissive mode. At this time, according to the present invention, the liquid crystal orientation above the sub-pixel electrode 520 is controlled to cause the reflective light 403 to penetrate the liquid crystal layer 465. That is, when the white sub-pixel area 3104 is driven to transmit white light to raise display brightness and dilute the color purity in the reflective mode, the color gamut is thereby varied with different brightness levels.

Thus, the overall chromaticity and color gamut for the two modes may be controlled to a desired value, which may be substantially the same chromaticity or different chromaticity.

### Fourth Embodiment

FIG. 7 is a sectional view schematically showing one main pixel area of the transmissive LCD device according to the fourth embodiment which is modified from the third embodiment. Elements in FIG. 7 repeated from FIG. 6 use the same numerals. The fourth embodiment differs from the third embodiment in the sub-pixel electrode 525. The sub-pixel electrode 525 can be opaque and reflective materials such as aluminum, aluminum alloy or silver. That is, the sub-pixel electrode 525 is a reflective layer. In another aspect, the sub-pixel electrode 525 may comprise a reflective portion and a transmissive portion (not shown).

An operational example of this embodiment is illustrated hereinafter.

When operating in transmissive mode, a backlight 402 from the backlight device 401 passes through the primary color regions R, G and B once. Note that the sub-pixel electrode 525 blocks backlight 402 emitted from the backlight device 401 because the sub-pixel electrode 515 is opaque. That is, the white sub-pixel area 3104 does not transmit light (i.e. the white sub-pixel area 3104 is dark) in the transmissive mode. Thus, the color gamut can keep the same value for the transmissive mode.

When operating in reflective mode, a reflective light 403 from an exterior light source (not shown) passes through the primary color regions R, G and B twice and is reflected by the semi-transmissive layer 405, causing display color in the reflective mode to be darker than that in transmissive mode. At this time, according to the invention, the white sub-pixel area 3104 displays a white light to raise brightness by reflection of the sub-pixel electrode 515; furthermore, the white sub pixel area can be driven to display different brightness levels to change the color gamut in reflective mode.

### Fifth Embodiment

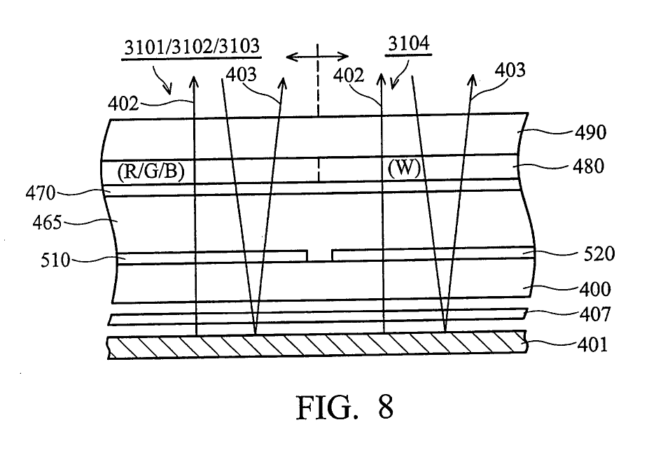

FIG. 8 is a sectional view schematically showing one main pixel area of the transmissive LCD device according to the third embodiment of the present invention. The main pixel area comprises red, green and blue sub-pixel areas 3101, 3102 and 3103 and a white sub-pixel area 3104. For simplicity, the three primary color sub-pixel areas 3101, 3102, and 3103 and a white sub-pixel area 3104 are respectively shown in FIG. 8.

A first substrate 400, serving as a lower substrate, can be a glass substrate including an array of pixel driving elements (not shown), such as an array of thin film transistors (TFTs). A backlight device 401 is disposed at the outer side (i.e. the backside) of the first substrate 400. Three sub-pixel electrodes 510 and a sub-pixel electrode 520 are formed on the first substrate 400, wherein each sub-pixel electrode 510 is located in each primary color sub-pixel area 3101/3102/3103 and the sub-pixel electrode 520 is located in the white sub-pixel area 3104. Note that a representative sub-pixel electrode 510 is shown in FIG. 6. Each sub-pixel electrode 510 and the sub-pixel electrode 520 can be transparent conductive material such as ITO (indium tin oxide) or IZO (indium zinc oxide).

A second substrate 490, such as glass, opposite the first substrate 400 is provided. The second substrate 490 serves as an upper substrate. A color filter 480 is formed on the inner side of the second substrate 490. The color filter 480 comprises three primary color regions R, G and B and a white region W. The white region W may have no color layer or have a transparent resist layer. Note that a representative primary color region R/G/B is shown in FIG. 8. Each sub-pixel electrode 510 corresponds to each color region R/G/B. The sub-pixel electrode 520 corresponds to the white region W.

A common electrode 470 is then formed on an inner side of the second substrate 490. The common electrode 470 may be an ITO or IZO layer. In FIG. 5, liquid crystal molecules fill a space between the first substrate 400 and the second substrate 490 to form a liquid crystal layer 465. The liquid crystal orientation of the liquid crystal layer 465 is controlled by electric field generating electrodes such as sub-pixel electrodes 510 and 520 and the common electrode 470. A diffusive layer 407 can be an optical component in the backlight device 401 or independent from the backlight device 401. The backlight device 401 further comprises a reflective film (not shown). The diffusive layer 407 can be disposed between the first substrate 400 and the reflective film of the backlight device 401. The reflective film of the backlight device 401 can reflect the ambient and the diffusive layer 407 can provide a scattering reflection light. Also, the diffusive layer 407 may be disposed between a lower polarizer (not shown) and a PCF (or DBEF, not shown). When the ambient light penetrates the lower polarizer and then passes through the diffusive layer 407, the diffusive layer 407 will depolarized the linear polarized light. Non-depolarized light will keep passing through the PCF and the depolarized light will be reflected. Therefore, no matter where the diffusive layer 407 is disposed, the transmissive LCD can be operated both in transmissive mode and in reflective mode.

When operating in transmissive mode, a backlight 402 from the backlight device 401 passes through the primary color regions R, G and B once. According to this embodiment, the liquid crystal orientation above the sub-pixel electrode 520 is controlled to transmit backlight at different brightness light levels. In one aspect of this embodiment, when the white sub-pixel area 3104 is driven to not transmit light (i.e. the white sub-pixel area 3104 is dark), thus, the color gamut is preserved in the transmissive mode. And in another aspect of this embodiment, when the white sub-pixel area 3104 is allowed to transmit light, so the color gamut will change with the different brightness levels.

When operating in reflective mode, a reflective light 403 from an exterior light source (not shown) passes through the primary color regions R, G and B twice and is reflected by the reflective film of the backlight device 401 or is reflected by the PCF, causing display color in the reflective mode to be darker than that in the transmissive mode. At this time, according to the present invention, the liquid crystal orientation above the sub-pixel electrode 520 is controlled to cause the reflective light 403 to penetrate the liquid crystal layer 465. That is, when the white sub-pixel area 3104 is driven to transmit white light to raise display brightness and dilute the color purity in the reflective mode, thereby the color gamut varies with different brightness level.

Thus, the overall chromaticity and color gamut for the two modes may be controlled to a desired value, which may be substantially the same chromaticity or different chromaticity.

The invention improves the chromaticity of the conventional LCD devices by introducing a white sub-pixel to provide white light in the transmissive and reflective modes. The white sub-pixel comprises a reflective portion reflecting the white light when in the reflective mode. Thus, the chromaticity of the reflective mode approaches that of transmissive mode, improving display quality.

Normalizing Chromaticity and Adjusting Color Gamut

According to the invention, the white sub-pixel is driven to pass white light to dilute color purity so that the LCD device can display brighter images with faithful color purity in the reflective mode. Because the LCD device in the transmissive mode has less reflection in the white sub-pixel area, to obtain better display performance, the white sub-pixel is suggested to be driven by at least 1% of maximum reflection ratio of white sub-pixel.

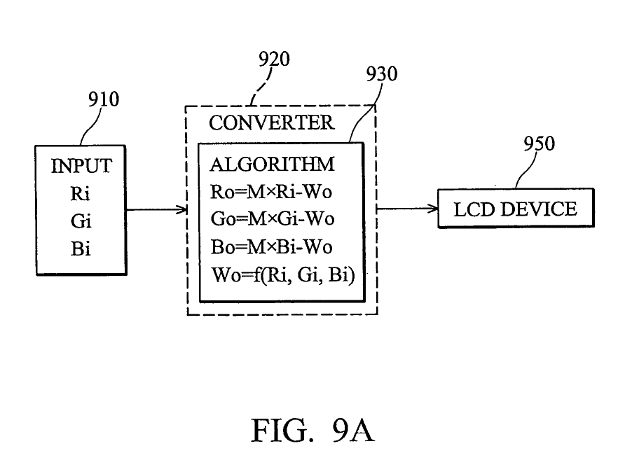

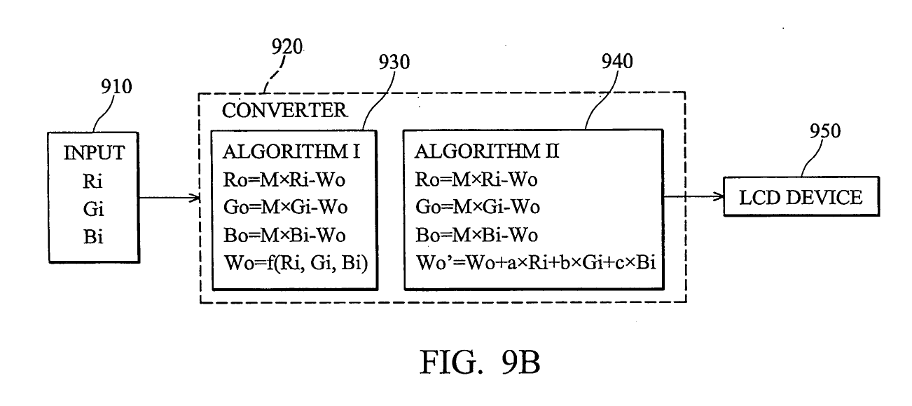

FIG. 9A is a block diagram illustrating a method of displaying balanced chromatic image for a liquid crystal display (LCD) device in a transmissive display mode. Signals of Ri, Gi and Bi 910 are input to a signal converter 920 converting the signals of Ri, Gi and Bi 910 to output signals of Ro, Go, Bo, Wo to the LCD device 950. The RGB to RGBW conversion algorithm 930 for transmissive mode is designed to keep the same chromaticity in four-color RGBW displays as that in primary three color RGB displays, formula as below:
Ri:Gi:Bi=(Ro+Wo):(Go+Wo):(Bo+Wo)

Ri, Gi, and Bi denote color inputs of red, green and blue respectively. Ro, Go, Bo, and Wo denote color outputs of red, green, blue, and white respectively. Ro, Go, Bo, and Wo can be given as:
Ro=M×Ri−Wo
Go=M×Gi−Wo
Bo=M×Bi−Wo
Wo=f(Ri,Gi,Bi)

M is a predetermined constant and f(Ri, Gi, Bi) can be regarded as a function to show white color component extracted from color inputs of Ri, Gi, and Bi. Note that the f(Ri, Gi, Bi) is dependent from conditions of viewing angles, brightness, or applying electrical fields.

FIG. 9B is a block diagram illustrating a method of displaying balanced chromatic image for a liquid crystal display (LCD) device in a reflective display mode. Signals of Ri, Gi and Bi 910 are input to a signal converter 920 converting the signals of Ri, Gi and Bi 910 to output signals of Ro, Go, Bo, Wo′ to the LCD device 950.

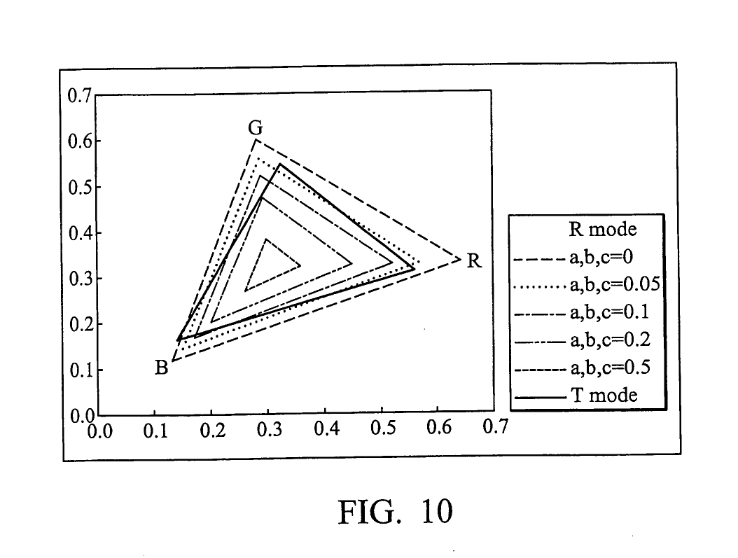

For reflective mode, the algorithm I and II 930 and 940 converted from RGB to RGBW are represented as follows:
Ro=M×Ri−Wo
Go=M×Gi−Wo
Bo=M×Bi−Wo
Wo′=Wo+a×Ri+b×Gi+c×Bi,

where 0<a<1, 0<b<1, or 0<c<1 respectively. FIG. 10 is a CIE chromaticity diagram showing color gamut in a reflective mode and in a transmissive mode according to the present invention. If a=b=c=0 (i.e. Wo′=Wo), then the same algorithm converted from RGB to RGBW is achieved for transmissive mode and reflective mode. The color gamut in transmissive mode is quite greater than that in reflective mode. The chromaticity variations between transmissive mode and reflective mode are so significant that different white input signals are separately introduced to balance the color gamut and chromaticity in transmissive mode and reflective mode. To balance the chromaticity of an LCD display, the white sub-pixel brightness is modulated so as to dilute the color purity in the reflective mode. Therefore, the chromaticity of transmissive mode approaches that of reflective mode. When a=b=c=0.05 (i.e. Wo′≠Wo), a color gamut in the reflective mode approaches a color gamut in the transmissive mode. To achieve the desired color gamut, it is not limited that a=b=c.

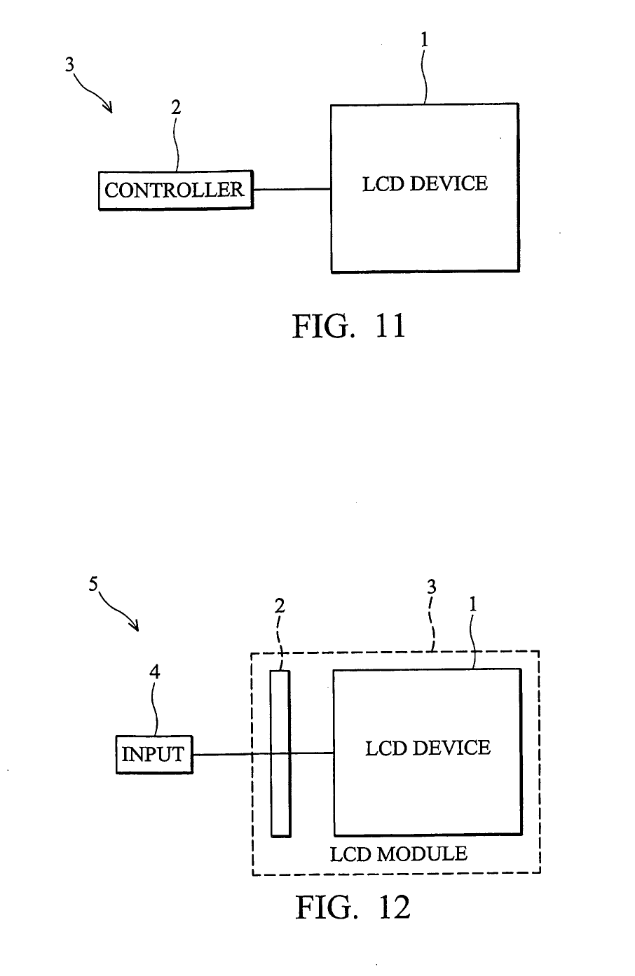

FIG. 11 is a schematic diagram of an LCD module 3 comprising an embodiment of an LCD device 1. The LCD device 1 is coupled to a controller 2, forming an LCD module 3 as shown in FIG. 11. The controller 3 comprises source and a gate driving circuits (not shown) to control the LCD device 1 to render image in accordance with an input. The controller 3 may comprise a converter converting input signals of Ri, Gi and Bi to output signals of Ro, Go, Bo, Wo and Wo′ to the LCD device 1.

FIG. 12 is a schematic diagram of an electronic device 5, incorporating an LCD module 3 comprising an embodiment of the LCD device 1. An input device 4 is coupled to the controller 2 of the LCD module 3. Input device 4 includes a processor or the like to input data to the controller 2 to render an image. The electronic device 5 may be a portable device such as a PDA, notebook computer, tablet computer, cellular phone, or a desktop computer, for example.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of displaying balanced chromatic image for a liquid crystal display (LCD) device with a transmissive display mode and a reflective display mode, comprising:
displaying the LCD device in the transmissive mode with a first white output signal Wo; and
displaying the LCD device in the reflective mode with a second white output signal Wo′,
wherein the first white output signal Wo is different from the second white output signal Wo′.

2. The method according to claim 1, further comprising:
providing the LCD device, wherein the LCD device includes a red, a green, a blue, and a white subpixels;
inputting signals of Ri, Gi and Bi into a signal converter;
converting the signals of Ri, Gi and Bi with the signal converter to output signals of Ro, Go, Bo, Wo, and Wo′ to the LCD device;
wherein displaying the transmissive mode includes transmitting the output signals of Ro, Go, Bo and Wo corresponding to the red, green, blue, and white subpixels respectively,
wherein displaying the reflective mode includes transmitting the output signals Ro, Go, Bo and Wo′ to the red, green, blue, and white subpixels respectively.

3. The method according to claim 2, wherein the relationships among the output signals of Ro, Go, Bo and Wo are respectively represented as:
Ro=M×Ri−Wo
Go=M×Gi−Wo
Bo=M×Bi−Wo
Wo=f(Ri,Gi,Bi),
where M is a predetermined constant and f(Ri, Gi, Bi) is a function to show the first white output signal Wo extracted from the input signals of Ri, Gi and Bi.

4. The method according to claim 3, wherein f(Ri, Gi, Bi) is dependent from conditions of viewing angles, brightness, or applying electrical fields.

5. The method according to claim 2, wherein the relationships among the output signals of Ro, Go, Bo and Wo′ are respectively represented as:
Ro=M×Ri−Wo
Go=M×Gi−Wo
Bo=M×Bi−Wo
Wo′=Wo+a×Ri+b×Gi+c×Bi,
where 0<a<1, 0<b<1, or 0<c<1 respectively.

6. The method according to claim 5, wherein the second white output signal Wo′ equals Wo+a×Ri+b×Gi+c×Bi, where Wo=0, and 0<a<1, 0<b<1, or 0<c<1 respectively.

7. The method according to claim 1, wherein the second white output signal Wo′ is larger than the first white output signal Wo.

8. A method of displaying balanced chromatic image for a liquid crystal display (LCD) device with a transmissive display mode and a reflective display mode, comprising:
displaying the LCD device in the transmissive mode without a white output signal Wo′; and
displaying the LCD device in the reflective mode with a white output signal Wo′,
wherein the white output signal Wo′ equals a×Ri+b×Gi+c×Bi, where 0<a<1, 0<b<1, or 0<c<1 respectively.

9. The method according to claim 8, further comprising:
providing the LCD, wherein the LCD includes a red, a green, a blue, and a white subpixels;
inputting signals of Ri, Gi and Bi into a signal converter;
converting the signals of Ri, Gi and Bi with the signal converter to output signals of Ro, Go, Bo, and Wo′ to the LCD device;
wherein displaying the reflective mode includes transmitting the output signals Ro, Go, Bo and Wo′ to the red, green, blue, and white subpixels respectively.

10. The method according to claim 9, wherein when a=b=c=0.05, a color gamut in the reflective mode approaches a color gamut in the transmissive mode.

11. A liquid crystal display (LCD) device with three primary color sub-pixels and a white sub-pixel, comprising:
a first substrate and a second substrate disposed opposite each other with a liquid crystal layer interposed therebetween;
a transparent electrode disposed on the first substrate at each of the three primary color sub-pixels; and
an electrode with a reflective portion disposed on the first substrate at the white sub-pixel.

12. The LCD device according to claim 11, wherein the three primary color sub-pixels comprise a red, a green and a blue sub-pixels.

13. The LCD device according to claim 11, wherein the electrode with a reflective portion is a reflective electrode.

14. The LCD device according to claim 11, wherein the electrode with a reflective portion further comprises a transmissive portion.

15. The LCD device according to claim 11, wherein the three primary color sub-pixels comprise a reflective displaying mode and a transmissive displaying mode.

16. The LCD device according to claim 11, wherein the electrode with a reflective portion comprises aluminum, aluminum alloy or silver.

17. The LCD device according to claim 11, further comprising a backlight device disposed outside the first substrate, and a semi-transmissive layer disposed between the first substrate and the backlight device.

18. The LCD device according to claim 17, wherein the electrode with a reflective portion blocks light emitted from the backlight device.

19. The LCD device according to claim 11, further comprising a backlight device disposed outside the first substrate, and a diffusive layer disposed between the first substrate and the backlight device.

20. An LCD module, comprising:
the LCD device according to claim 11; and
a controller coupled to the LCD device to control the LCD device to render an image in accordance with an input.

21. The LCD module according to claim 20, wherein the controller comprises a converter converting input signals of Ri, Gi and Bi to output signals of Ro, Go, Bo, Wo, and Wo′ to the LCD device, wherein the output signals of Ro, Go, Bo and Wo correspond to a red, a green, a blue, and a white subpixels respectively in a transmissive mode, and wherein the output signals of Ro, Go, Bo and Wo′ correspond to the red, green, blue, and white subpixels respectively in a reflective mode.

22. An electronic device, comprising:
the LCD module according to claim 20; and
an input device coupled to the controller of the LCD module to control the LCD module to render an image.

23. An LCD module, comprising:
a liquid crystal display (LCD) device with three primary color sub-pixels and a white sub-pixel; and
a controller coupled to the LCD device to control the LCD device to render an image in accordance with an input,
wherein the controller comprises a converter converting input signals of Ri, Gi and Bi to output signals of Ro, Go, Bo, Wo, and Wo′ to the LCD device.

24. An electronic device, comprising:
the LCD module according to claim 23; and
an input device coupled to the controller of the LCD module to control the LCD module to render an image.
